(19) United States
(12) Patent Application Publication
(10) Pub. No.: US 2014/0175838 A1
(43) Pub. Date: Jun. 26, 2014

(54) Wheel Fender

(71) Applicants: Johann Epple, Marktoberdorf (DE); Paul Frei, Marktoberdorf (DE); Thomas Maier, Kaufbeuren (DE)

(72) Inventors: Johann Epple, Marktoberdorf (DE); Paul Frei, Marktoberdorf (DE); Thomas Maier, Kaufbeuren (DE)

(21) Appl. No.: 14/004,225

(22) PCT Filed: Nov. 24, 2011
(86) PCT No.: PCT/EP2011/070919

§ 371 Date: Nov. 21, 2013

(30) Foreign Application Priority Data
Mar. 10, 2011 (GB) 1104086.2

(51) Int. Cl. B62D 25/16

(52) U.S. Cl. CPC B62D 25/16
USPC 296/198

(57) ABSTRACT

A fender (3b) for a wheel on an agricultural vehicle having a cab, said fender comprising an inner contour (3d) proximal to the vehicle for attachment to the cab and a distal outer contour (3e) wherein the outer contour is radially inclined with respect to the inner contour.

### BACKGROUND OF THE INVENTION

1. Field of Invention

This invention relates to a wheel fender on an agricultural vehicle such as an agricultural tractor.

2. Description of Related Art

Agricultural tractors are provided with front and rear wheel fenders. The rear wheel fenders are usually attached directly to the tractor cab by bolts and the front wheel tractors are usually attached to brackets which are attached to the frame or chassis of the tractor.

The fender typically comprises a curved sheet of material having a width and two opposing longitudinal edges. The fender is typically narrower than the width of a standard tyre fitted to the tractor although certain tyres such as those used for row crop work may be narrower. The fender has an inner contour which when mounted to the tractor is proximal to the tractor and an opposing outer contour distal from the tractor. The outer contour is provided with a lip and the inner contour is provided with a flange. The lip on the outer contour extends radially inwards towards the wheel. The flange on the inner contour provides a means for attaching the fender to the tractor and the lip on the outer contour provides a means for attaching a fender extension or fender cover to the already mounted fender.

In order to reduce the pressure applied to the soil and therefore reduce the amount of ground compaction, for example when seeding, it may be necessary to mount wider tyres to the tractor or to use two tyres on one wheel hub. In such a case it is necessary to fix a fender extension to the existing fender, so that the width of the fender plus fender extension extends over the increased tyre width. The lip of the already mounted fender therefore does not extend over the increased width of the tyre or tyres and instead is in radial alignment with a part of the newly attached tyre or tyres. If the tractor is subjected to roll movement, it is possible that the lip of the outer contour of the fender, or another part of the fender comes into contact with the tyre causing damage to the tyre and fender and affecting the movement of the tractor.

It is desirable to provide a cab on a tractor which provides the driver with a great a view as possible through the side windows. It is therefore desirable to mount the fenders a low as possible to the cab so that a large a pane of glass as possible can be mounted to the sides of the cab. With this arrangement the distance between the lip and/or fender and the tyre is small and the lip and/or part of the fender may come into contact with the tyre when the tractor is subjected to roll movement.

### BRIEF SUMMARY OF THE INVENTION

It is an object of the present invention to provide a wheel fender for an agricultural vehicle which obviates or at least alleviates the problems associated with the prior art.

According to the invention there is provided a fender for a wheel on an agricultural vehicle having a cab as claimed in claim 1. Since the lip of the outer contour of the wheel fender is positioned at a greater radial distance from the wheel than the prior art allows, the tractor can undertake greater roll movement before the lip comes into contact with the tyre, or tyres. Moreover, the invention allows a fender to be mounted to a cab at a lower level than the prior art allows thus enabling a larger surface area of glass to be mounted to cab and improving driver visibility. Preferred features of the invention are set out in the dependent claims.

### BRIEF DESCRIPTION OF THE DRAWINGS

The invention will now be described, by example only with reference to the following drawings in which:

FIG. 1a is a side view of a tractor fitted with a front and rear wheel fender,

FIG. 1b is a more detailed perspective view of the rear wheel fender of FIG. 1a,

FIG. 2 is a cross sectional view along line A-A of FIG. 1a showing a wheel fender arrangement in accordance with the invention,

FIG. 3 is a more detailed view of FIG. 2,

FIG. 4 is a cross sectional view along line D-D of FIG. 2,

FIG. 5 is a cross sectional view along line A-A of FIG. 1a showing one embodiment of the wheel fender only, and

FIG. 6 is a cross sectional view along line A-A of FIG. 1a showing a second embodiment of the wheel fender only.

### DETAILED DESCRIPTION OF THE INVENTION

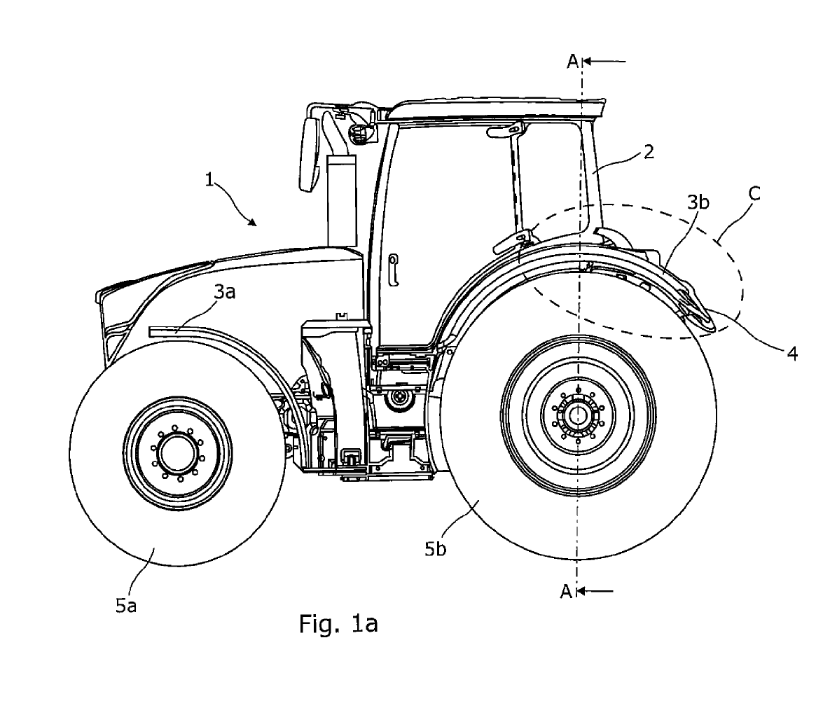

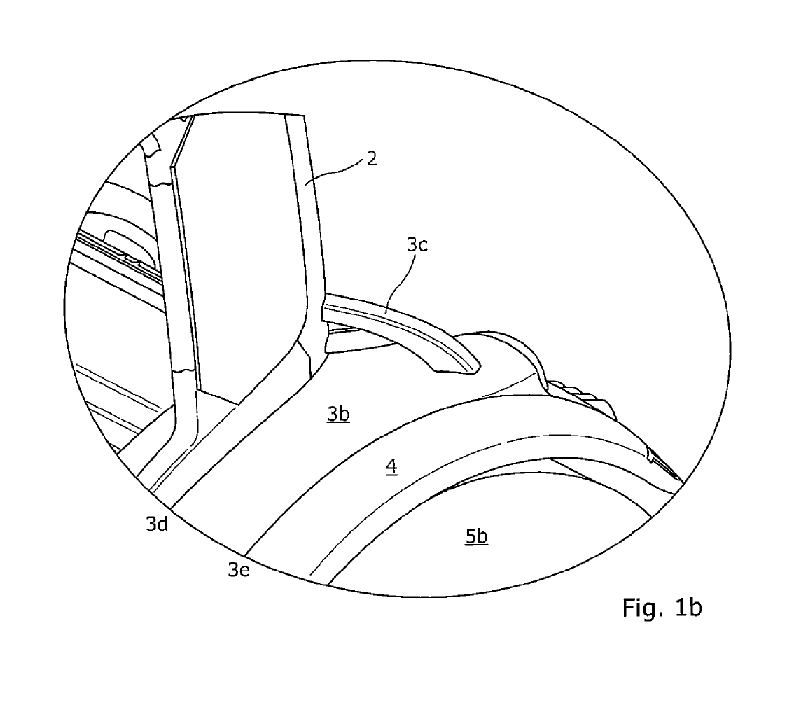

FIG. 1a is a side view of a tractor 1 having a cab 2, front and rear wheels 5a and 5b with respective front and rear wheel fenders 3a and 3b. Rear wheel fender 3b is provided with a fender extension 4 which is shown more clearly in FIG. 1b.

FIG. 1b is a more detailed perspective view of FIG. 1a showing the rear wheel fender 3b which has an inner contour 3d proximal to the tractor. The fender has an outer contour 3e which is distal from the tractor. The inner contour is provided with a flange 3g for attaching the fender to the tractor. Flange 3g is attached to the tractor cab 2. The outer contour is provided with a lip 3h (not visible in FIG. 1b). The lip 3h on outer contour 3e extends radially inwards towards the wheel 5b substantially perpendicular to the plane of the outside surface 3i of the fender. The flange 3g on inner contour 3d provides means for bolting the fender 3b to the cab 2. The lip 3h on the outer contour provides means for connecting a fender extension 4 to it. (In the case of the tractor fitted with a narrow tyre, a fender cover may be attached to lip 3h instead of a fender extension. This is done mainly for aesthetic reasons). The tractor 1 is also provided with a fender bracket 3c which provides a base onto which a light or mirror may be mounted.

The fender has four edges. Two arced edges of differing lengths and two edges of the same length defining the width of the fender.

By inner and outer contours it is meant the arced edges of the fender 3b from which the flange 3g and lip 3h extend respectively.

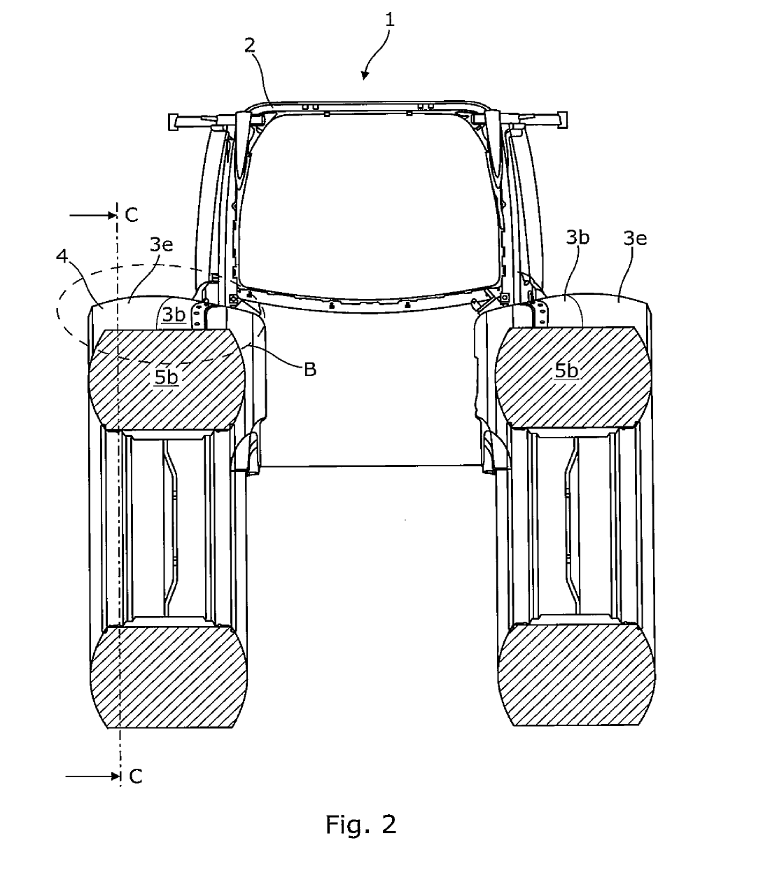

FIG. 2 is a cross sectional view of FIG. 1a along line A-A showing a fender arrangement in accordance with the invention. It is easier to see that a wheel 5b wider than the width of fender 3b has been fitted. This has the consequence that fender extension 4 must be fitted to lip 3h to increase the overall width of the fender. Since a wheel wider than the width of fender 3b has been fitted, lip 3h protrudes radially inwards towards the wheel in alignment with a part of the wheel. However, in accordance with the invention, the fender 3b is radially inclined so that the under surface 3j of fender 3b at the outer contour 3e is spaced further away from the wheel 5b than the under surface of the inner contour 3d. In other words the radius of the outer contour 3h is greater than the radius of the inner contour 3d. This has the effect that lip 3h is not as close to the wheel 5b as with the prior art and therefore the tractor can tolerate greater roll movement before the lip 3h interferes with the wheel 5b.

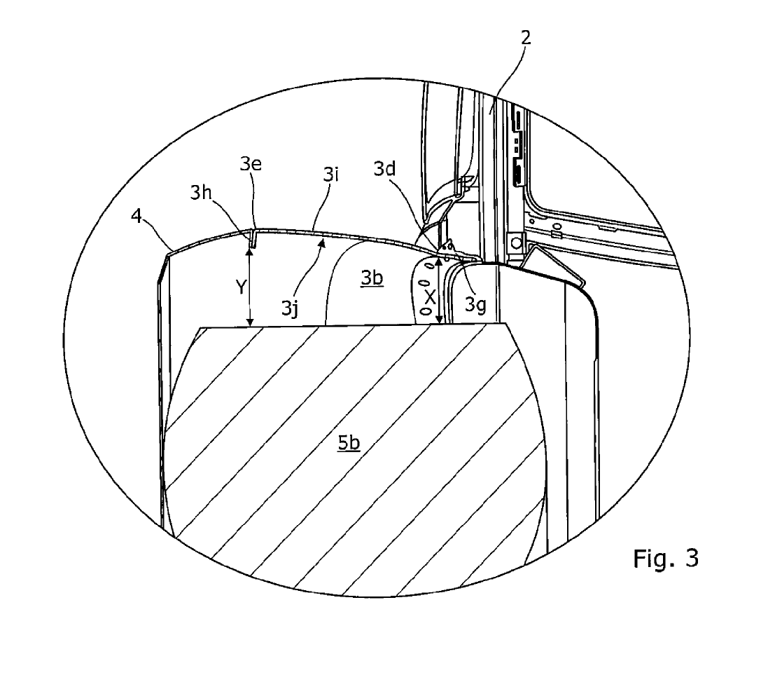

FIG. 3 shows the area referenced B in FIG. 2 in greater detail. Because the fender 3b is radially inclined from the inner contour 3d to the outer contour 3e, the free end of lip 3h of the outer contour 3e is spaced further away from the wheel 5b (indicated as distance Y in FIG. 3) than the distance of inner contour 3d from wheel 5b (indicated as distance X in FIG. 3). Distance Y is measured perpendicular to a surface of the outer contour and distance X is measured perpendicular to a surface of the inner contour. Lip 3e extends radially inwardly towards the wheel 5b. It can be seen that if the fender 3b was not radially inclined the lip 3h would protrude closer to the wheel than both flange 3g and inner contour 3d and thus interfere with the wheel 5b during roll movement of the tractor.

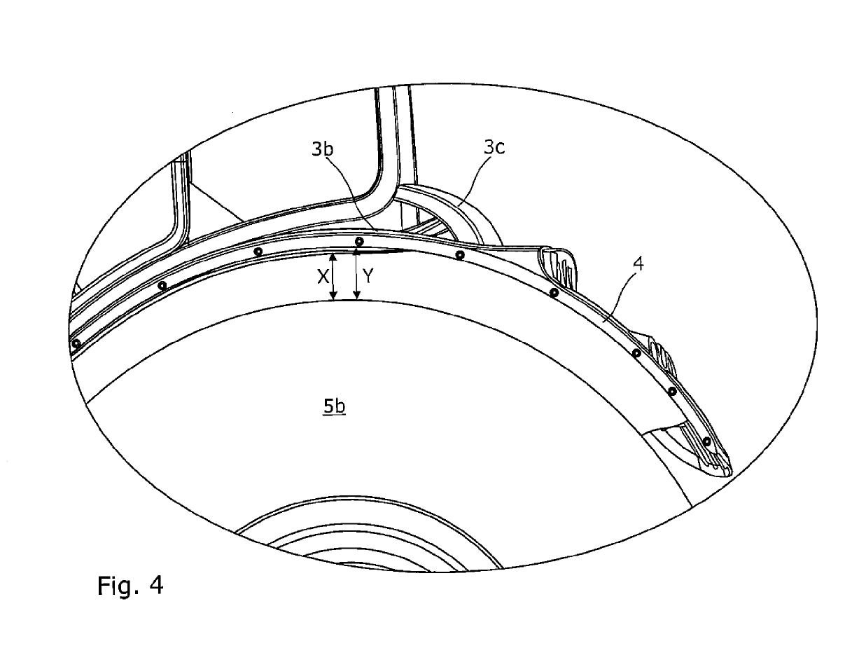

FIG. 4 is a cross sectional view along line D-D of FIG. 2 showing the space between the outer contour 3e of the fender and the wheel 5b is greater than the space between the inner contour 3d and the wheel 5b.

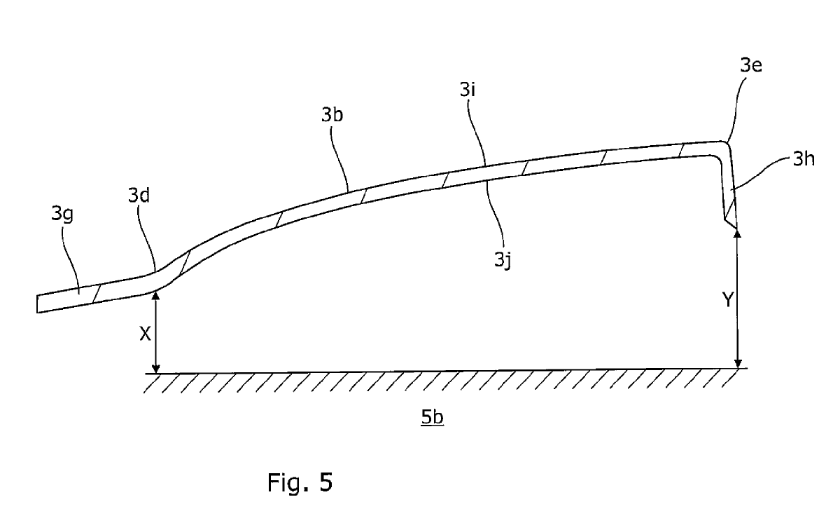

FIG. 5 is a cross sectional view of the rear wheel fender along line A-A of FIG. 1a showing the shape of the rear right hand side fender only. As can be seen, flange 3g is radially inclined at a gentle angle until inner contour 3d. From inner contour 3d the fender is radially inclined at a steeper angle and has a convex outer surface 3i. Outer contour 3e is provided with a lip 3h which is radially inclined towards the wheel. Lip 3h is substantially perpendicular to the plane of the outer surface 3i of fender 3b.

In the shown embodiment lip 3h is perpendicular to the plane of outer surface 3i. It is envisaged that the lip 3h may be parallel or inclined in any specific angle towards outer surface 3i without leaving the scope of the invention.

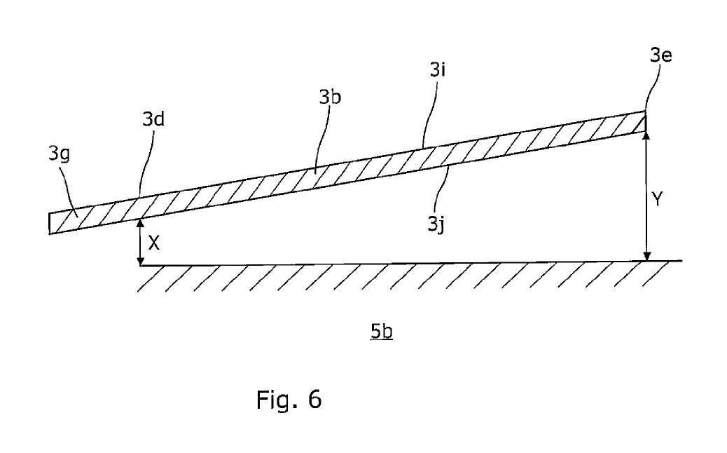

FIG. 6 shows a cross sectional view of a second embodiment of the fender in which the flange 3g and upper surface 3i of the fender 3b are inclined at the same angle. In this embodiment fender 3b is not provided with a lip.

The use of a fender in accordance with the invention has the advantage that the tractor can experience greater roll movement without the fender coming into contact with a tyre than the prior art allows.

Moreover the fender can be fitted to the cab at a lower height than the prior art allows (thus giving the driver a clearer view through the side windows of the cab.)

1. A fender for a wheel on an agricultural vehicle having a cab, said fender comprising an inner contour for attachment to the cab and a distal outer contour, wherein the outer contour is radially inclined with respect to the inner contour.

2. A fender as claimed in claim 1 wherein the outer contour is provided with a lip which extends radially inwards towards the wheel and wherein the distance between a free end of the lip and the wheel is greater than the distance between the inner contour and the wheel, said distances measured along lines extending perpendicularly from the surfaces of the outer and inner contours respectively.

3. (canceled)

4. (canceled)

5. (canceled)

6. A fender as claimed in claim 1 wherein the outer surface of the fender is convex.

7. A fender as claimed in claim 2 wherein the outer surface of the fender is convex.

8. A fender as claimed in claim 1 wherein the distance between an under surface of the outer contour and the wheel is greater than the distance between an under surface of the inner contour and the wheel, said distances measured along lines extending perpendicularly from the under surfaces of the outer and inner contours respectively.

9. A fender as claimed in claim 2 wherein the distance between an under surface of the outer contour and the wheel is greater than the distance between an under surface of the inner contour and the wheel, said distances measured along lines extending perpendicularly from the under surfaces of the outer and inner contours respectively.

10. A tractor having a fender as claimed in claim 1.

11. A tractor having a fender as claimed in claim 2.
